(19) United States
(12) Patent Application Publication
(10) Pub. No.: US 2026/0251758 A1
(43) Pub. Date: Aug. 27, 2026

(54) DISTRIBUTED RADAR TEST EMULATION APPARATUS AND SYSTEM

(71) Applicant: Keysight Technologies, Inc., Santa Rosa, CA (US)

(72) Inventor: Bernhard Holzinger, Boeblingen (DE)

(21) Appl. No.: 19/063,983

(22) Filed: Feb. 26, 2025

(51) Int. Cl. G01S 7/40

(52) U.S. Cl. CPC G01S 7/4086

(57) ABSTRACT

An apparatus and system for testing distributed aperture radar are described. The apparatus includes a first chamber having a first array of transmit and receive antennae disposed on one side of the first chamber and a first radar device under test. At least one of the first array of transmit and receive antennae is connected to a first signal processor and the first array of transmit and receive antennae is adapted to emulate a target. The apparatus also includes a second chamber comprising a second array transmit and receive antennae disposed on one side of the second chamber and a second radar device under test. At least one of the second array of transmit and receive antennae is connected to a second signal processor and the second array of transmit and receive antennae are adapted to emulate the target.

### BACKGROUND

Modern cars increasingly incorporate so-called Advanced Driver Assistance Systems (ADAS). Among these, already well established are Emergency Brake Assist (EBA) and Lane Assist (LA) systems, with the goal being fully autonomous vehicles. All these systems require sensors to allow an electronic (or engine) control unit (ECU) of the vehicle to gather sufficient information indicative of the surrounding environment. Examples of commonly used and/or proposed ADAS sensors include ultrasonic sensors, video cameras, radar sensors and lidar (or LiDAR) sensors. Among these, radar is generally conceded to have clear advantages in fog and perhaps other adverse environmental conditions.

One major challenge when developing ADAS equipped vehicles is to verify proper operations in the myriad of different scenarios which might occur in real traffic. To carry out this verification in real life is not a practical. First, it is hard to achieve the required coverage (i.e. to actually test all relevant scenarios) as this would require too much time (millions of hours). Second, some of the most stringent real life tests are unethical because they are dangerous by their very nature. Adding to these test barriers is the fact that all sensors must be verified in concert as it is important to verify that the ECU makes the right decision based on the data it is gathering from all sensors.

Consequently, auto manufacturers and even the sensor module vendors themselves are eager to electronically emulate driving conditions on a virtual platform. In the case of radar, it is desirable that the test system of the virtual platform be synchronized with the radar of the device under test (DUT) to consistently emulate the same targets during all phases of the radar.

To provide more accurate emulation of radar targets, the angle of resolution needs to be improved. The greater the angular resolution, the greater is the ability to distinguish targets, especially when the targets are comparatively close together. Moreover, the higher the angular resolution, targets of different shapes can also be more readily resolved.

While LiDAR systems provide a comparatively high degree of angular resolution, atmospheric interference has challenged their implementation. These shortcomings have led to the implementation of multiple radar elements in a vehicle to improve the angular resolution of the radar devices. However, current techniques to test such multiple radar systems (sometimes referred to as distributed radar systems) suffer from certain shortcomings.

With reference to FIG. 1, a known system designed to test a Distributes Aperture Radar (DAR) system in a vehicle 102 is described. The vehicle 102 comprises a left radar transceiver 104, a center radar transceiver 106 and a right radar receiver 108. An object is disposed at a first distance from the radar transceivers 104, 106, 108. Just by way of illustration, the object at a first location 110 may be a radar target simulator (RTS) used to test the DAR system of the vehicle 102. As shown by the solid lines, the object is disposed at three angles relative to the left, center and right transceivers 104, 106, 108. Moving the object to a second location 112, which is colinear with the first location 110, places the object at a second distance from the left, center and right transceivers 104, 106, 108. As shown by the dotted lines the second location 112 is disposed at three angles relative to the left, center and right transceivers 104, 106, 108, and as clearly shown, the three angles of the solid lines from the first location 110 are different than the three angles from the second location 112. This results in parallax issue due to the different angles when one RTS is used. As such, emulating a target at different locations with a single RTS is not accurate.

What is needed, therefore is an apparatus and system for testing DAR systems that overcome at least the noted shortcoming of the known methods noted above.

### SUMMARY

According to a representative embodiment, an apparatus for testing distributed aperture radar (DAR) is described. The apparatus comprises: a first chamber comprising a first array of transmit and receive antennae disposed on one side of the first chamber and a first radar device under test (RUT) disposed on an opposing side of the first chamber, wherein at least one of the first array of transmit and receive antennae is connected to a first signal processor and the first array of transmit and receive antennae is adapted to emulate a target; and a second chamber comprising a second array transmit and receive antennae disposed on one side of the second chamber and a second RUT disposed on an opposing side of the second chamber, wherein at least one of the second array of transmit and receive antennae is connected to a second signal processor and the second array of transmit and receive antennae are adapted to emulate the target.

According to another representative embodiment, a system for testing for testing a DAR is described. The system comprises: a controller comprising a processor and a memory that stores executable instructions; a first chamber comprising a first array of transmit and receive antennae disposed on one side of the first chamber and a first RUT disposed on an opposing side of the first chamber, wherein at least one of the first array of transmit and receive antennae is connected to a first signal processor and the first array of transmit and receive antenna is adapted to emulate a target; and a second chamber comprising a second array transmit and receive antennae disposed on one side of the second chamber and a second RUT disposed on an opposing side of the second chamber, wherein at least one of the second array of transmit and receive antennae is connected to a second signal processor and the second array of transmit and receive antennae are adapted to emulate the target.

### BRIEF DESCRIPTION OF THE DRAWINGS

The above and other aspects and features of the inventive concepts will become readily apparent from the detailed description that follows with reference to the accompany drawings, in which:

FIG. 1 is a perspective view of a related system for testing automotive radar having a DAR system.

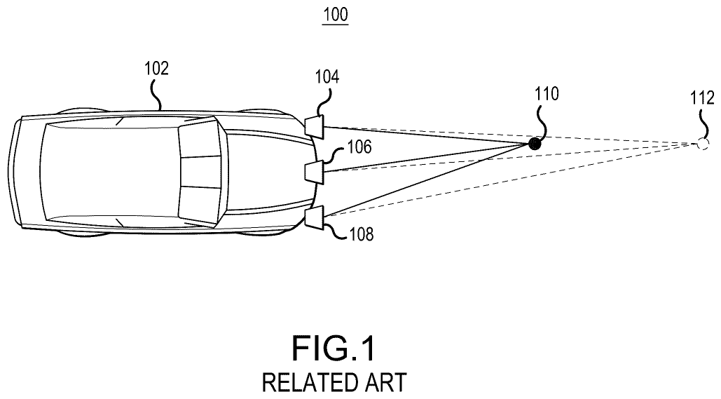

FIG. 2 is a simplified block diagram of a system for testing for testing a DAR system comprising individual radars of the DAR into separate anechoic chambers in accordance with a representative embodiment.

FIG. 3 shows a nanowall comprising an array of transmit and receive antennae in accordance with a representative embodiment.

FIG. 4 is a simplified block diagram of a miniature radar target simulator (mRTS) for use in a system for testing for testing a DAR system in accordance with a representative embodiment.

FIG. 5A is a simplified block diagram showing connections between transmit and receive antennae in separate anechoic chambers in accordance with a representative embodiment.

FIG. 5B is a simplified block diagram showing other connections between transmit and receive antennae in separate anechoic chambers in accordance with a representative embodiment.

FIG. 5C is a simplified block diagram showing connections between transmit and receive antennae in separate anechoic chambers comprising shared RTS's in accordance with a representative embodiment.

FIG. 6 is a simplified block diagram showing the placement of individual radar devices in separate anechoic chambers and their emulation of at target relative to three radar devices deployed in a vehicle, in accordance with a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, or “coupled to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In commonly assigned U.S. Pat. No. 11,543,489, filed May 6, 2020, entitled “Multi-Target Radar Emulator System”, the entire disclosure of which is specifically incorporated herein by reference herein, techniques are described for achieving target emulation in radars such as FMCW (frequency-modulated continuous-wave) radars. Similarly, in commonly assigned U.S. Pat. No. 11,686,814 filed Dec. 7, 2020 entitled “Frequency Modulated Continuous Wave (FMCW) Radar Target Emulation with Synchronized Modulation Reflection Devices,” the entire disclosure of which is specifically incorporated herein by reference, other target emulation devices such as FMCW radar devices are described. Various components, including the function of RTS's described in these incorporated patents are contemplated for use in the systems of the present teachings. However, the RTS's described in these incorporated patents are meant to be illustrative and not limiting. Other radar target simulators within the purview of one of ordinary skill in the art having the benefit of this disclosure are contemplated. Finally, FMCW radars constitute nearly 100% of the current automotive radar market and such modulation schemes are contemplated for use in connection with the various representative embodiment, Some modern radars use “Fast Chirp FMCW.” In some cases, the fast FMCW chirps are not uniformly spaced in time, and instead their start times are dithered to improve features like isolation from other oncoming vehicles that may have their own radars. These radars extract relative velocity by measuring the phase change (slip) from chirp to chirp of the returned signal. Such modulation schemes are contemplated for use with the present apparatuses and systems for testing DAR devices and systems. By a FMCW radar this is interpreted as a certain distance and radial velocity of the detected target. Furthermore, and as alluded to above, in various representative embodiments, emulation is carried out using FMCW. However, if the signal was delayed and frequency shifted for achieving the same goal as in FMCW, the apparatuses and systems of the present teachings beneficially can be implemented with such other modulation schemes. Finally, while the representative embodiments are primarily directed to testing of FMCW DAR's, the present teachings are not limited to FMCW DAR's. Rather, the present teachings are contemplated for use in testing of DAR's that are based on other radar technologies. Accordingly, because other radar technologies are contemplated radar signals may be described as being “manipulated” to carry out the desired emulation. As such, “manipulated” is contemplated to cover both FMCW modulation schemes as well as other contemplated radar schemes.

The present teachings relate generally to an apparatus and system for testing radar transceiver devices (“radar devices”) for use in DAR applications. The apparatuses and systems of the various representative embodiments are adapted to test the general Key Performance Indicators (KPI) of a DAR system. KPI's comprise measures of accuracy and resolution in all five dimensions of the detection space of the radar: distance, azimuth angle, elevation angle, Doppler radial velocity, and radar cross section (RCS). By contrast, these measures in known known systems for DARs require corner reflectors in a big open space, whereas the apparatuses and systems for testing DARs in various embodiments can be done in a comparatively small area as described more fully below. Moreover, and as described in the above-incorporated patents, distance can either be emulated by delaying the response or (for FMCW) by shifting the response in frequency. Doppler radar is emulated by introducing the phase progression as noted above and/or by directly introducing the frequency shift due to doppler. RCS is emulated by adjusting the amplitude of the returned signal accordingly.

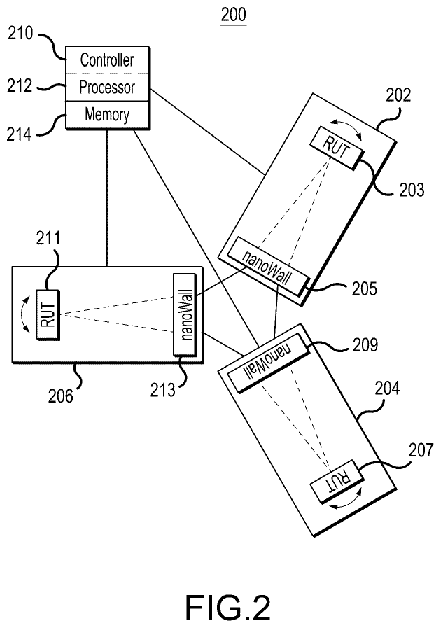

FIG. 2 is a simplified block diagram of a system 200 for testing for testing a DAR system comprising individual radars of the DAR into separate anechoic chambers in accordance with a representative embodiment.

The system 200 comprises a first anechoic chamber (hereafter “chamber”) 202, a second chamber 204 and third chamber 206. The first chamber 202 comprises a first RUT 203 and a first nanowall 205. The second chamber 204 comprises a second RUT 207 and a second nanowall 209. The third chamber 206 comprises a third RUT 211 and a third nanowall 213.

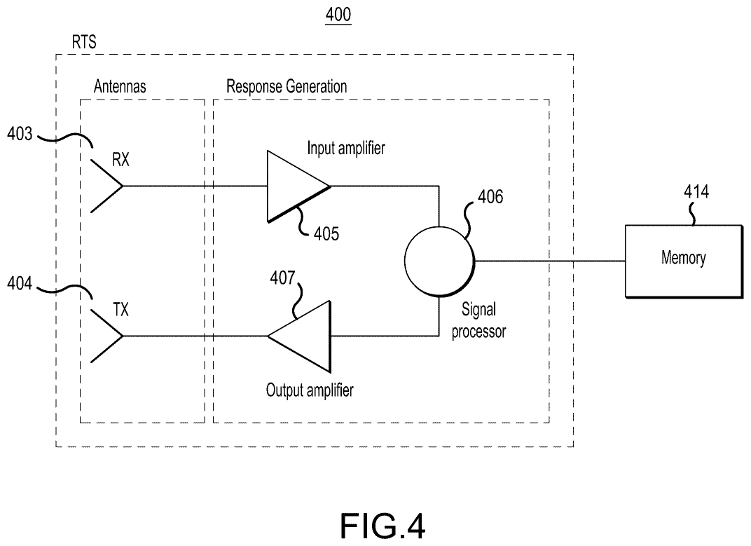

As described more fully below, each of the first, second and third nanowalls 205, 209, 213 comprises an array of transmit and receive antennae (not shown in FIG. 2) that are connected to electronic components in a variety of ways to emulate targets to be detected by the respective RUTs. Connections between various components of the nanowalls are selectively carried out with known signal transmission lines (alternately waveguides) and antenna elements (e.g., horn antennae) selected for transmission of radar signals at frequencies commonly used in radar systems, particularly those deployed in vehicle radar systems. Furthermore, and as described more fully below, in certain representative embodiments, transmit and receive antennae pair are selectively connected to amplifiers and a signal processor to provide a radar target simulator (RTS) that provide a radar picture element (rixel). One representative configuration of an RTS is described more fully below in connection with FIG. 4 and in greater detail in the patents incorporated by reference above. The various components of the nanowalls include the arrays of antennae, the electronic components that form the RTS's and the connections (waveguides and antennae) are adapted to be provided in a multilayer printed circuit board (PCB) arrangement fabricated in accordance with known manufacturing techniques and materials, which are well-known to one of ordinary skill in the art.

The system 200 comprises a system controller 210 that comprises a system processor 212 coupled to a system memory 214. The system controller 210 is adapted to support the system processor 212, which executes software instructions (code) to carry out the various tests of the first, second and third RUTs 203, 207, 211 by providing commands to signal processors selectively connected to the arrays of antenna of the nanowalls 205, 209, 213 to send and receive test signals, which as noted above and as described in connection with the incorporated patents noted above are illustratively FMCW signals that are transmitted and received to emulate targets in the path of the RUT's 203, 207, 211.

The system processor 212 is tangible and non-transitory, is representative of one or more processors. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The system processor 212 (and other processors) of the present teachings is an article of manufacture and/or a machine component. The system processor 212 for the system controller 210 is configured to execute software instructions stored in the system memory 214 to perform functions as described in the various embodiments herein. The system processor 212 may be a general-purpose processor or may be part of an application specific integrated circuit (ASIC). The system processor 212 may also be (or include) a microprocessor, a microcomputer, a processor chip, a controller, a microcontroller, a digital signal processor (DSP), a state machine, or a programmable logic device. The system processor 212 may also be (or include) a logical circuit, including a programmable gate array (PGA) such as a FPGA, or another type of circuit that includes discrete gate and/or transistor logic. The system processor 212 may be (or include) a central processing unit (CPU), a graphics processing unit (GPU), or both. Additionally, the system processor 212 may comprise multiple processors, parallel processors, or both. Multiple processors may be included in, or coupled to, a single device or multiple devices.

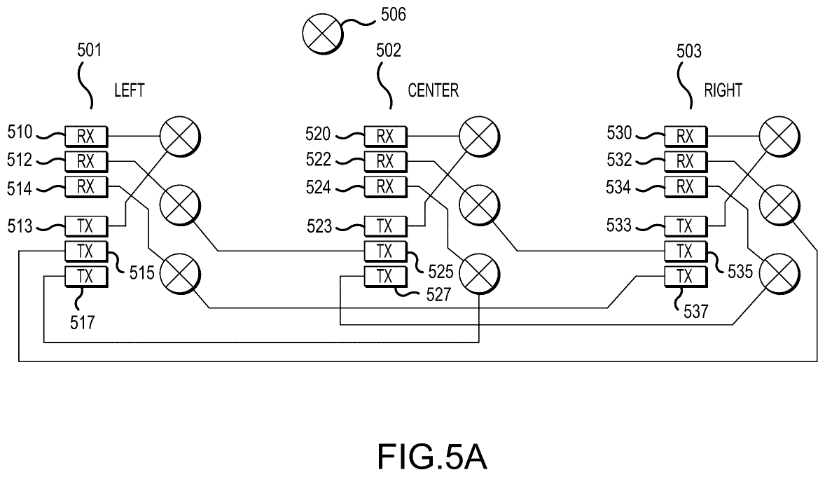

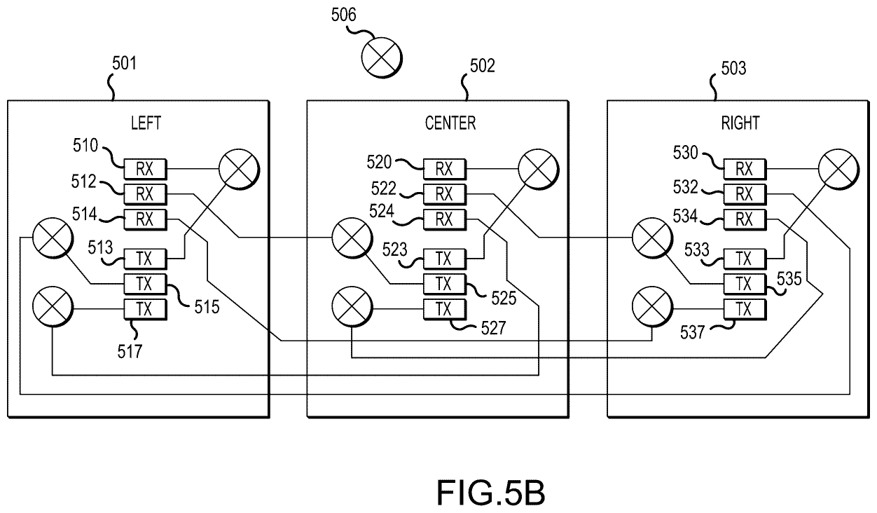

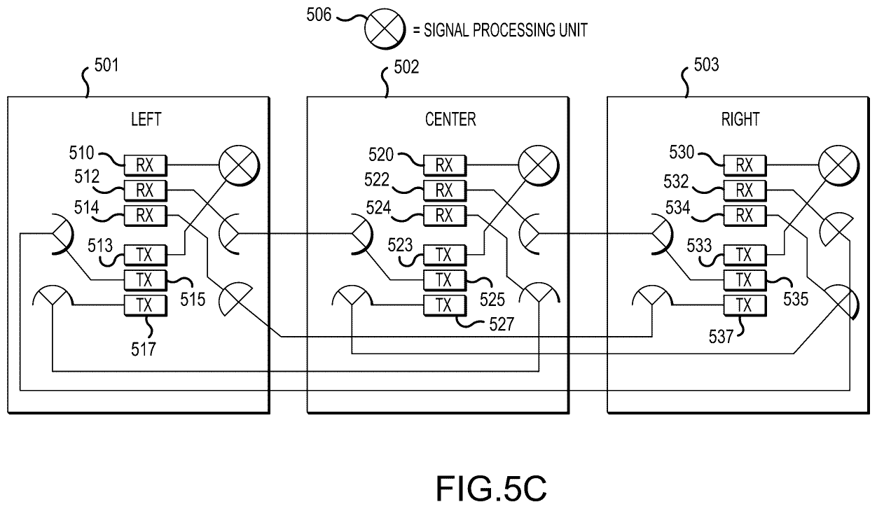

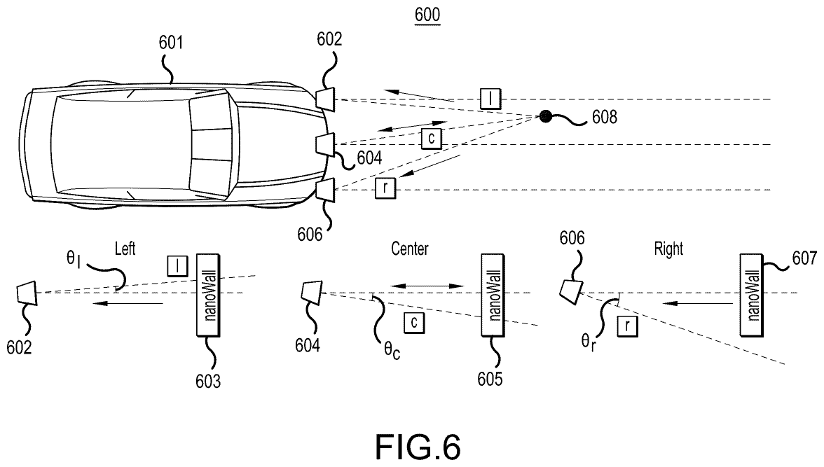

The system memory 214 may comprise a main memory, a static memory, or both, where the memories may communicate with each other via a bus (not shown). The system memory 214 described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The system memory 214 of the present teachings is an article of manufacture and/or machine component. The system memory 214 includes one or more computer-readable mediums from which data and executable instructions (e.g., to carry out the processes described in connections with FIGS. 5A-6) can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known to one of ordinary skill in the art. Memories of the present teachings may be volatile or non-volatile, secure and/or encrypted, unsecure and/or unencrypted. The system controller 210, the system memory 214 and the system processor 212 may be housed within or linked to a workstation (not shown) such as a computer or another assembly of one or more computing devices, a display/monitor, and one or more input devices (e.g., a keyboard, joysticks and mouse) in the form of a standalone computing system, a desktop or a tablet, for example.

As described more fully below, the system controller 210 issues control commands to the components of the first, second and third nanowalls 205, 209, 213 to carry out various tests of the first, second and third RUT's 203, 207, 211.

As alluded to above, the RUT's 203, 207, 211 are contemplated for use in a DAR system, such as deployed in a vehicular radar system. Illustratively, the RUT's 203, 207, 211 may be a left RUT, a center RUT and a right RUT disposed, for example, on the front bumper of an automobile. It is emphasized that the number of RUT's described in the various representative embodiments are merely illustrative and not intended to be limiting. More generally, two or more RUT's may be used in emulation of targets in the path of the vehicle. As such, the illustrative three chamber test system may be modified to emulate the function of DAR systems having more or fewer radar devices. Finally, and as will become clearer as the present description continues, as shown by arrows each of the RUT's 203, 207, 211 is adapted to rotate to emulate the location of the RUT relative to a target in its path being emulated. Although only one arrow is shown in FIG. 2 for each of the RUT's, more generally, the RUT's are adapted to rotate to alter both the azimuth angle and elevation angle to enable emulation of targets in the areal view of the DAR system being tested.

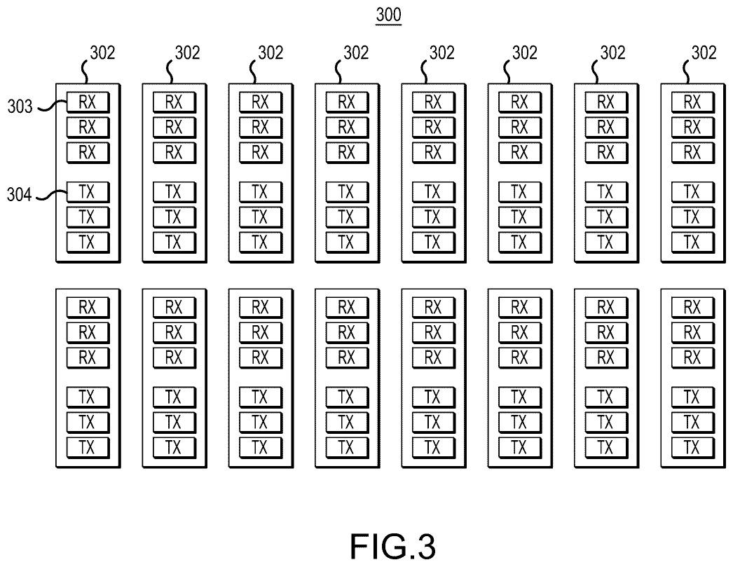

FIG. 3 shows a nanowall 300 comprising an array of transmit and receive antennae in accordance with a representative embodiment. The nanowall is contemplated for use in the system 200 described above in connection with FIG. 2. Certain aspects and details of the nanowall 300 are common to those described above in connection with FIG. 2 and may not be repeated to avoid obscuring the presently described representative embodiments.

As shown, the nanowall 300 comprising a plurality of columns 302 each comprising a plurality of receive (RX) antennae 303 and a plurality of transmit (TX) antennae 304. It is noted that the number of columns 302 and the number of RX antennae 303 and TX antennae 304 is selected to provide the nanowall 300 is merely illustrative, and more or fewer columns 302, RX antennae 303 and TX antennae 304 are contemplate by the present teachings. As described more fully below, each of the RX antennae 303 and TX antennae 304 is adapted to be connected to various components of a miniature radar target simulator (mRTS), and through these connections is adapted to provide rixel for emulating targets in the path of the RUT. A combination of rixels in turn is adapted to provide a radar scene emulator (RSE). The mRTS is described more fully below and in the above-incorporated patents. Notably, switching between mRTS's enables the target to be moved laterally and vertically. It is also possible to place a target in between mRTS's by using interpolation techniques. As alluded to above, and as described more fully below, the selection of TX and RX antennae 303, 304 pairs to generate the desired target emulation is carried out by a signal processor (not shown in FIG. 3) that is adapted to execute commands stored in a local memory (not shown in FIG. 3), or in system memory 214. Generally, as described more fully below, executable commands from the system controller 210 may be provided to a local controller (not shown in FIG. 3), which in turn controls the signal processor of the mRTS being activated to generate a rixel using to emulate the target.

In a selected radar scene emulator (RSE), a complete wall spanning ±70° in azimuth and ±15° in elevation is filled up by such a matrix of TX and RX antennae, with the TX and RX antennae selectively coupled to electronic components to provide mRTS's. Notably, in the present teachings, a subsection of the field of view (e.g., 10° in azimuth and elevation 10°) may be emulated by a nanowall 300. As such, the RUT's may be adapted to rotate left and right, and up and down to carry out this emulation. In this way, at any given time a subsection of the complete field of view may be emulated. Sequential emulation based on this enables an entire field of view to be emulated. As will be appreciated by one of ordinary skill in the art, the resolution of an individual RUT is comparatively low (e.g., 2° as noted above). As such, an individual RUT is not capable of resolving rixels of the nanowall 300, a known interpolation technique can be used to emulate a target disposed between two rixels. As such, because the radars in a DAR operate coherently together, an overall comparatively high angular resolution is achieved. Just by way of illustration, the angular resolution of a deployed DAR illustratively comprising three RUT's (left, center, right) may be below 2°, whereas the DAR system will have a much better resolution. As will become clearer as the present description continues, nanowalls described in connection with FIGS. 2 and 3 are used to emulate targets in the overall field of view in a piecewise fashion. Illustratively, to emulate two targets that are comparatively close to one another, a plurality of nanowalls is used, with each nanowall adapted to cover an angular portion of the desired field of view which includes these two targets. In the three radar device DAR system noted above, for example, the angular resolution of left, center and right RUT's may be tested by moving targets using different rixels formed by selected mRTS's within the selected piece of the field of view. Then another piece of the field of view may be chosen by rotating the RUT's and testing the angular resolution for this next piece of the field of view. As such, emulating targets with nanowalls of the present teachings enables the area to be covered by each array of TX and RX antennae that form the nanowall 300 to be kept comparatively small, with the ability to move the segment of the field of view under test across the complete field of view of the radar being carried out by tilted and/or rotating the RUTs across a selected range. Notably, and as alluded to above, the testing across a desired field of view is carried out based on commands from the system controller 210 that are ultimately executed by the individual signal processors of the mRTS's used to generate the RSE. Stated somewhat differently, as described more fully below, by selective connection of TX/RX antennae that provide the mRTS's, radar targets may be emulated using command signals from the system controller 210 to the plurality of chambers that comprise the system (e.g., first, second and third chambers 202, 204, 206 of the system 200 described in connection with FIG. 2).

FIG. 4 is a simplified block diagram of a miniature radar target simulator (mRTS) 400 for use in a system for testing a DAR system in accordance with a representative embodiment. Certain aspects and details of the mRTS 400 are common to those described above in connection with FIGS. 2 and 3, and may not be repeated to avoid obscuring the presently described representative embodiments.

The mRTS 400 comprises a TX antenna 403, an RX antenna 404, input amplifier 405, a signal processor 406 and an output amplifier 407. The signal processor 406 is connected to a memory 414, which stores instructions when executed by the signal processor 406 is adapted to carry out various functions to emulate targets of a DAR according to the present teachings.

The signal processor 406 is tangible and non-transitory, is representative of one or more processors. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The signal processor 406 (and other processors) of the present teachings is an article of manufacture and/or a machine component. The signal processor 406 is configured to execute software instructions stored in the local memory 414 to perform functions as described in the various embodiments herein. The signal processor 406 may be a general-purpose processor or may be part of an application specific integrated circuit (ASIC). The signal processor 406 may also be (or include) a microprocessor, a microcomputer, a processor chip, a controller, a microcontroller, a digital signal processor (DSP), a state machine, or a programmable logic device. The signal processor 406 may also be (or include) a logical circuit, including a programmable gate array (PGA) such as a FPGA, or another type of circuit that includes discrete gate and/or transistor logic. The signal processor 406 may be (or include) a central processing unit (CPU), a graphics processing unit (GPU), or both. Additionally, the signal processor 406 may comprise multiple processors, parallel processors, or both. Multiple processors may be included in, or coupled to, a single device or multiple devices.

The local memory 414 may comprise a main memory, a static memory, or both, where the memories may communicate with each other via a bus (not shown). The local memory 414 described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The local memory 414 of the present teachings is an article of manufacture and/or machine component. The local memory 414 includes one or more computer-readable mediums from which data and executable instructions (e.g., to carry out the processes described in connections with FIGS. 5A-6) can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known to one of ordinary skill in the art. Memories of the present teachings may be volatile or non-volatile, secure and/or encrypted, unsecure and/or unencrypted. The local memory 414 and the signal processor 406 may be housed within or linked to a workstation (not shown) such as a computer or another assembly of one or more computing devices, a display/monitor, and one or more input devices (e.g., a keyboard, joysticks and mouse) in the form of a standalone computing system, a desktop or a tablet, for example.

As noted above, the local memory 414 stores instructions that are executed by the signal processor 406 to transmit signals between various components to generate rixels used in the testing of a DAR system. These instructions may also be stored in the system memory 214 and provided to the signal generator 406. Generally, the system processor 212 and signal generator 406 perform system wide and local functions, respectively, useful in emulating various targets in a DAR system.

While many aspects and details of the mRTS 400 are described in the above-incorporated patents, there are certain aspects of the currently described representative embodiments that provide various useful functions of the present teachings. Notably, and as will be described more fully below in connection with various representative embodiments, the components of the mRTS 400 may not be co-located. Rather, in some representative embodiments, the various components of the resultant mRTS used to emulate a target by generating rixels may be disposed in different columns of the same nanowall, or may be disposed on different nanowalls altogether. For example, an mRTS comprising the signal processor 406, input and output amplifiers 405, 407, the memory 414 and the RX antenna 403 (and input amplifier) may be connected and located on one of the nanowalls 205, 209, 213, whereas the TX antenna 404 (and output amplifier) may be located at another location on the same nanowall as the signal processor 406, input and output amplifiers 405, 407, the memory 414 and the RX antenna 403. Alternatively, the TX antenna 404 may be located on another one of the nanowalls 205, 209, 213. Accordingly, and as described more fully below in connection with FIGS. 5A-5C RX antenna-signal processor-TX antenna pairings, which span the different chambers are contemplated. As such, and just by way of example, an RX antenna of one column of one chamber can be paired with an mRTS and TX antenna of another column of the same chamber, or another chamber to carry out the emulation of targets.

Still alternatively, in some representative embodiments, two separate signal processors located apart may be used to generate the desired signals at the TX antenna for emulating a particular target. In this way, the functions of the signal processor 406 are shared between two signal processors. Just by way of illustration, an RX antenna (and input amplifier) may be disposed on first nanowall 205 and the TX antenna (and output amplifier) needed to emulate a particular target may be a component of the third nanowall 213. In this arrangement, the signal processor of the RX antenna on the first nanowall 205 executes instructions to transmit a command signal to the signal processor of the TX antenna on the third nanowall. Upon receipt of the command signal, the second signal processor connected to the TX antenna selected to generate a rixel used to emulate a particular target or portion thereof executes a command signal to transmit the signal from the TX antenna of the third nanowall 213. As such, and as described more fully below, the components that comprise an mRTS according to the various representative embodiments afford a great deal of flexibility and thereby provide a system adapted to emulate targets of a DAR system.

FIG. 5A is a simplified block diagram showing connections between transmit and receive antennae in separate anechoic chambers in accordance with a representative embodiment. Certain aspects and details of the various components of the representative embodiment of FIG. 5A are common to those described above in connection with FIGS. 2-4, and may not be repeated to avoid obscuring the presently described representative embodiments.

As alluded to above, RX antenna-signal processor-TX antenna pairings using TX antennae, RX antennae and signal processors in different columns and/or chambers result in mRTS's that span different columns and/or chambers enable a wide variety of emulation targets. Certain combinations are described below. FIGS. 5A-5C describe certain illustrative pairings of RX antenna-signal processor-TX antenna pairing to effect emulation of a DAR in accordance with various representative embodiments. The described pairings are merely illustrative and certainly not exhaustive of possible embodiments based on the present teachings.

Turning to FIG. 5A, a particular column of three nanowalls (e.g., left, center and right nanowalls) are shown, with each column comprising three TX antennae and three RX antennae. Of course, the concepts described in connection with each column of the respective nanowalls may be expanded to make connections at all columns of the three nanowalls.

A left nanowall column 501 disposed in a left chamber (not shown in FIG. 5A) comprises a plurality of RX antennae 510, 512, 514 and a plurality of TX antennae 513, 515, 517. A column of the center nanowall column 502 disposed in a center chamber (not shown in FIG. 5A) comprises a plurality of RX antennae 520, 522, 524 and a plurality of TX antennae 523, 525, 527. A right nanowall column 503 disposed in a right chamber (not shown in FIG. 5A) comprises a plurality of RX antennae 530, 532, 534 and a plurality of TX antennae 533, 535, 537. As shown, selected connections between TX and RX antennae can be made using respective signal processors 506. While a number of connections are shown, only a few are described in detail to highlight the various connections.

As shown, RX antenna 510 is configured to receive a signal from a RUT in the left nanowall, provide this signal to the signal processor 506, which is a component of the left nanowall column 501, and in turn provides a command signal to TX antenna 513 located in the same nanowall as the RX antenna 510. As noted above, the connections between the signal processor 506, the RX antenna 510 and the TX antenna 513 may be made using signal transmission lines (waveguides) disposed in the circuit board of the left nanowall comprising the left nanowall column 501. In this way, a target in the path of the left RUT can be emulated with a signal from a TX antenna in the same chamber as the RUT. Moreover, in this representative configuration, the signal processor 506 is a component of the left nanowall column 501. Accordingly, and as noted above, with these connections mRTS is realized and comprises the RX antenna 510 (and input amplifier (not shown in FIG. 5A)), the signal processor 506 and the TX antenna 513 (an output amplifier (not shown in FIG. 5A)) all disposed on the left nanowall column 501.

RX antenna 512 is configured to receive a signal from a RUT in the left nanowall, provide this signal to the signal processor 506, which is a component of the left nanowall column 501, and in turn provides a command signal to TX antenna 525 located in the center nanowall. Again, the connections between the signal processor 506, the RX antenna 512 and the TX antenna 525 may be made using signal transmission lines (waveguides) disposed in the circuit board of the left and center nanowalls comprising the left and center nanowall columns 501, 502. In this way, a target in the path of the left RUT can be emulated with a signal from a TX antenna in the center chamber. Moreover, in this representative configuration, the signal processor 506 is a component of the left nanowall column 501. Accordingly, and as noted above, with these connections mRTS is realized and comprises the RX antenna 512 (and input amplifier (not shown in FIG. 5A)) and the signal processor 506 are disposed on the left nanowall, and the TX antenna 525 (an output amplifier (not shown in FIG. 5A)) is disposed on the center nanowall column 502. As such, the mRTS is cobbled by making selective connections to components in the left and center nanowall columns 501, 502.

RX antenna 514 is configured to receive a signal from a RUT in the left nanowall, provide this signal to the signal processor 506, which is a component of the left nanowall column 501, and turn provides a command signal to TX antenna 537 located in the right nanowall 503. Again, the connections between the signal processor 506, the RX antenna 514 and the TX antenna 537 may be made using signal transmission lines (waveguides) disposed in the circuit board of the left and right nanowalls comprising the left and center nanowall columns 501, 503. In this way, a target in the path of the left RUT can be emulated with a signal from a TX antenna in the right chamber. Moreover, in this representative configuration, the signal processor 506 is a component of the left nanowall column 501. Accordingly, and as noted above, with these connections mRTS is realized and comprises the RX antenna 514 (and input amplifier (not shown in FIG. 5A)) and the signal processor 506 are disposed on the left nanowall, and the TX antenna 537 (an output amplifier (not shown in FIG. 5A)) is disposed on the right nanowall 503. As such, the mRTS is cobbled by making selective connections to components in the left and right nanowalls 501, 503.

FIG. 5B is a simplified block diagram showing connections between transmit and receive antennae in separate anechoic chambers in accordance with a representative embodiment. Certain aspects and details of the various components of the representative embodiment of FIG. 5B are common to those described above in connection with FIGS. 2-5A, and may not be repeated to avoid obscuring the presently described representative embodiments.

Turning to FIG. 5B, a particular nanowall column of three nanowalls (e.g., left, center and right nanowalls) are shown, with each nanowall column comprising three TX antennae and three RX antennae. Of course, the concepts described in connection with each nanowall column of the respective nanowalls may be expanded to make connections at all nanowall columns of the three nanowalls.

A left nanowall column 501 disposed in a left chamber (not shown in FIG. 5B) comprises a plurality of RX antennae 510, 512, 514 and a plurality of TX antennae 513, 515, 517. A center nanowall column 502 disposed in a center chamber (not shown in FIG. 5B) comprises a plurality of RX antennae 520, 522, 524 and a plurality of TX antennae 523, 525, 527. A right nanowall column 503 disposed in a right chamber (not shown in FIG. 5B) comprises a plurality of RX antennae 530, 532, 534 and a plurality of TX antennae 533, 535, 537. As shown, selected connections between TX and RX antennae can be made using respective signal processors 506. While a number of connections are shown, only a few are described in detail to highlight the various connections.

As shown, RX antenna 510 is configured to receive a signal from a RUT in the left nanowall column 501, provide this signal to the signal processor 506, which is a component of the left nanowall column 501, and in turn provides a command signal to TX antenna 513 located in the same nanowall as the RX antenna 510. As noted above, the connections between the signal processor 506, the RX antenna 510 and the TX antenna 513 may be made using signal transmission lines (waveguides) disposed in the circuit board of the left nanowall comprising the left nanowall column 501. In this way, a target in the path of the left RUT can be emulated with a signal from a TX antenna in the same chamber as the RUT. Moreover, in this representative configuration, the signal processor 506 is a component of the left nanowall column 501. Accordingly, and as noted above, with these connections mRTS is realized and comprises the RX antenna 510 (and input amplifier (not shown in FIG. 5A)), the signal processor 506 and the TX antenna 513 (an output amplifier (not shown in FIG. 5A)) all disposed on the left nanowall column 501.

RX antenna 512 is configured to receive a signal from a RUT in the left nanowall, provide this signal to the signal processor 506, which is a component of the center nanowall column 502, and in turn provides a command signal to TX antenna 525 located in the center nanowall. Again, the connections between the signal processor 506, the RX antenna 512 and the TX antenna 525 may be made using signal transmission lines (waveguides) disposed in the circuit board of the left and center nanowalls comprising the left and center nanowall columns 501, 502. In this way, a target in the path of the left RUT can be emulated with a signal from a TX antenna in the center chamber. Moreover, in this representative configuration, the signal processor 506 is a component of the center nanowall column 502. Accordingly, and as noted above, with these connections mRTS is realized and comprises the RX antenna 512 (and input amplifier (not shown in FIG. 5B)) is a component of the left nanowall column 501, and the signal processor 506 and TX antenna 525 (an output amplifier (not shown in FIG. 5A)) is disposed on the center nanowall column 502. As such, the mRTS is cobbled by making selective connections to components in the left and center nanowall columns 501, 502.

RX antenna 514 is configured to receive a signal from a RUT in the left nanowall, provide this signal to the signal processor 506, which is a component of the right nanowall 503, and turn provides a command signal to TX antenna 537 located in the right nanowall 503. Again, the connections between the signal processor 506, the RX antenna 514 and the TX antenna 537 may be made using signal transmission lines (waveguides) disposed in the circuit board of the left and right nanowalls comprising the left and center nanowall columns 501, 503. In this way, a target in the path of the left RUT can be emulated with a signal from a TX antenna in the right chamber. Moreover, in this representative configuration, the signal processor 506 is a component of the right nanowall 503. Accordingly, and as noted above, with these connections mRTS is realized and comprises the RX antenna 514 (and input amplifier (not shown in FIG. 5A)) is disposed on the left nanowall column 501, and signal processor 506 and the TX antenna 537 (an output amplifier (not shown in FIG. 5B)) are disposed on the right nanowall 503. As such, the mRTS is cobbled by making selective connections to components in the left and right nanowalls 501, 503.

FIG. 5C is a simplified block diagram showing connections between transmit and receive antennae in separate anechoic chambers comprising shared RTS's in accordance with a representative embodiment. Certain aspects and details of the various components of the representative embodiment of FIG. 5C are common to those described above in connection with FIGS. 2-5B, and may not be repeated to avoid obscuring the presently described representative embodiments.

Turning to FIG. 5C, a particular column of three nanowalls (e.g., left, center and right nanowalls) are shown, with each nanowall column comprising three TX antennae and three RX antennae. Of course, the concepts described in connection with each nanowall column of the respective nanowalls may be expanded to make connections at all nanowall columns of the three nanowalls.

A left nanowall column 501 disposed in a left chamber (not shown in FIG. 5C) comprises a plurality of RX antennae 510, 512, 514 and a plurality of TX antennae 513, 515, 517. A center nanowall column 502 disposed in a center chamber (not shown in FIG. 5C) comprises a plurality of RX antennae 520, 522, 524 and a plurality of TX antennae 523, 525, 527. A right nanowall column 503 disposed in a right chamber (not shown in FIG. 5C) comprises a plurality of RX antennae 530, 532, 534 and a plurality of TX antennae 533, 535, 537. As shown, selected connections between TX and RX antennae can be made using respective signal processors 506. While a number of connections are shown, only a few are described in detail to highlight the various connections. Notably, in the representative embodiments, when one-half of the symbol used for a signal processor 506 is shown, this means functionality of a signal processor 506 is shared. In practice, a signal processor 506 of one nanowall performs certain functions, and a signal processor of another nanowall performs other functions.

As shown, RX antenna 510 is configured to receive a signal from a RUT in the left nanowall column 501, provide this signal to the signal processor 506, which is a component of the left nanowall column 501, and in turn provides a command signal to TX antenna 513 located in the same nanowall as the RX antenna 510. As noted above, the connections between the signal processor 506, the RX antenna 510 and the TX antenna 515 may be made using signal transmission lines (waveguides) disposed in the circuit board of the left nanowall comprising the left nanowall column 501. In this way, a target in the path of the left RUT can be emulated with a signal from a TX antenna in the same chamber as the RUT. Moreover, in this representative configuration, the signal processor 506 is a component of the left nanowall column 501. Accordingly, and as noted above, with these connections mRTS is realized and comprises the RX antenna 510 (and input amplifier (not shown in FIG. 5A)), the signal processor 506 and the TX antenna 513 (an output amplifier (not shown in FIG. 5A)) all disposed on the left nanowall column 501.

RX antenna 512 is configured to receive a signal from a RUT in the left nanowall, provide this signal to the signal processor 506, which is a component of the left nanowall column 501, and in turn provides a command signal to TX antenna 525 located in the center nanowall column 502. Notably, as shown the signal processor 506 is a component of the center nanowall column 502. In this arrangement, the functions of the signal processors 506 on the left and center nanowall columns 501, 502 are shared. Again, the connections between the signal processor 506, the RX antenna 512 and the TX antenna 525 may be made using signal transmission lines (waveguides) disposed in the circuit board of the left and center nanowalls comprising the left and center nanowall columns 501, 502. In this way, a target in the path of the left RUT can be emulated with a signal from a TX antenna in the center chamber. Moreover, in this representative configuration, the signal processors 506 are components of the left nanowall column 501 and the center nanowall column 502 and share functions. Accordingly, and as noted above, with these connections mRTS is realized and comprises the RX antenna 512 (and input amplifier (not shown in FIG. 5C)) is a component of the left nanowall column 501, and the signal processor 506, and TX antenna 525 (an output amplifier (not shown in FIG. 5A)) and signal processor 506 are disposed on the center nanowall column 502. As such, the mRTS is cobbled by making selective connections to components in the left and center nanowall columns 501, 502 with functions shared by the respective signal processors 506 disposed on the left and center nanowall columns 501, 502. For purposes of illustration, and not limitation, this sharing may mean the signal processor 506 of the left nanowall may be adapted to receive the signal at the TX antenna 512 and provide this signal to the signal processor 506 of the center nanowall column 502. The signal processor 506 on the center nanowall column 502 in turn sends commands to the TX antenna 525 on the second nanowall column 502.

RX antenna 514 is configured to receive a signal from a RUT in the left nanowall, provide this signal to the signal processor 506, which is a component of the right nanowall 503, and turn provides a command signal to TX antenna 537 located in the right nanowall 503. Notably, as shown the signal processor 506 is a component of the right nanowall 503. In this arrangement, the functions of the signal processors 506 on the left and right nanowall columns 501, 503 are shared. Again, the connections between the signal processors 506, the RX antenna 514 and the TX antenna 537 may be made using signal transmission lines (waveguides) disposed in the circuit board of the left and right nanowalls comprising the left and right nanowall columns 501, 503. In this way, a target in the path of the left RUT can be emulated with a signal from a TX antenna in the right chamber. Moreover, in this representative configuration, the signal processor 506 is a component of the right nanowall column 503. Accordingly, and as noted above, with these connections mRTS is realized and comprises the RX antenna 514 (and input amplifier (not shown in FIG. 5A)) is disposed on the left nanowall column 501, and signal processor 506 on the left nanowall column 501, and the TX antenna 537 (an output amplifier (not shown in FIG. 5B)) and signal processor 506 are disposed on the right nanowall column 503. As such, the mRTS is cobbled by making selective connections to components in the left and right nanowall columns 501, 503.

For purposes of illustration, and not limitation, this sharing may mean the signal processor 506 of the left nanowall column 501 may be adapted to receive the signal at the RX antenna 514 and provide this signal to the signal processor 506 of the right nanowall column 503. The signal processor 506 on the right nanowall column 503 in turn sends commands to the TX antenna 537 on the right nanowall 503.

FIG. 6 is a simplified block diagram showing the placement of individual radar devices in separate anechoic chambers and their emulation of at target relative to three radar devices deployed in a vehicle, in accordance with a representative embodiment. Certain aspects and details of the various components of the representative embodiment of FIG. 6 are common to those described above in connection with FIGS. 2-5C, and may not be repeated to avoid obscuring the presently described representative embodiments.

Turning to FIG. 6, a vehicle 601 comprises a left radar device 602, a center radar device 604 and a right radar device 606, that transmit radar waves in front of the vehicle, which are incident on a target 608. These waves are reflected at different angles as shown.

Beneath the scene including the vehicle, the reflected beams from the center radar device 604 is emulated from a left nanowall 603 and incident at an angle θₗ, and thus are representative of the radar signal reflected back to the left radar device 602. The reflected beams from a center nanowall 605 are incident at an angle θ_{c}, and thus are representative of the radar signal reflected back to the center radar device 604. The reflected beams from the center radar device 604 is emulated with a right nanowall 607 and are incident at an angle θᵣ, and thus are representative of the radar signal reflected back to the right radar device 606. As will be appreciated, by the present teachings, a signal from one radar device can be manipulated by the nanowall and returned to other radar devices radars disposed in the other chambers. For each of these signal paths, the correct distance and angle of arrival may to be emulated. In this example, the signal from the center radar will be sent back to the same radar, but also to the two other radars in the left and right chamber.

Although various components, have been described with reference to several representative embodiments, it is understood that the words that have been used are words of description and illustration, rather than words of limitation. Changes may be made within the purview of the appended claims, as presently stated and as amended, without departing from the scope and spirit of the present teachings.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “teachings” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The inventive concepts also encompass a computer readable medium that stores instructions that cause a data processing system (such as the DSP of an NVA) to execute the methods described herein. A computer readable medium is defined to be any medium that constitutes patentable subject matter under 35 U.S.C. § 101 and excludes any medium that does not constitute patentable subject matter under 35 U.S.C. § 101. Examples of such media include non-transitory media such as computer memory devices that store information in a format that is readable by a computer or data processing system. More specific examples of non-transitory media include computer disks and non-volatile memories.

Aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A apparatus for testing distributed aperture radar (DAR), the apparatus comprising:
a first chamber comprising a first array of transmit and receive antennae disposed on one side of the first chamber and a first radar device under test (RUT) disposed on an opposing side of the first chamber, wherein at least one of the first array of transmit and receive antennae is connected to a first signal processor and the first array of transmit and receive antennae is adapted to emulate a target; and
a second chamber comprising a second array transmit and receive antennae disposed on one side of the second chamber and a second RUT disposed on an opposing side of the second chamber, wherein at least one of the second array of transmit and receive antennae is connected to a second signal processor and the second array of transmit and receive antennae are adapted to emulate the target.

2. The apparatus of claim 1, wherein the first signal processor is connected to a memory that stores instructions, which when executed by the first signal processor, cause a test signal received at a receive antenna to manipulate the test signal to be transmitted by a transmit antenna to emulate a target.

3. The apparatus of claim 2, wherein the receive antenna is in the first array and the transmit antenna is in the second array.

4. The apparatus of claim 2, wherein the first signal processor and the memory are shared by a transmit antenna from the first array and a receive antenna of the second array, and the first signal processor is adapted to manipulate a test signal received at the receive antenna of the second array, and provide the manipulated test signal to the transmit antenna of the first array for transmission back to the first radar device under test.

5. The apparatus of claim 2, wherein the first array of transmit and receive antennae is adapted to selectively transmit a test signal from the first RUT to the second array of transmit and receive antennae.

6. The apparatus of claim 5, wherein the test signal transmitted from the first RUT is received by a receive antenna of the first array, and the transmit antenna of the second array is adapted to provide the test signal from the first RUT to the second RUT to emulate the target at the second RUT.

7. The apparatus of claim 1, wherein a receive antenna of the second array is adapted to selectively transmit a second signal from the second RUT to a transmit antenna of the first array to emulate the target at the first radar device under test.

8. The apparatus of claim 1, further comprising: a third chamber comprising a third array of transmit and receive antennae disposed on one side of the third chamber and a third RUT disposed on an opposing side of the third chamber, wherein the third array of RTS's are adapted to emulate the target.

9. The apparatus of claim 8, wherein the first array of transmit and receive antennae is adapted to selectively transmit a signal from the first RUT to the second array transmit and receive antennae and/or to the third array of transmit and receive antennae.

10. The apparatus of claim 9, wherein the signal transmitted from the first RUT is received by a receive antenna of the first array of transmit and receive antennae, and the transmit antenna of the third array is adapted to transmit the signal from the first RUT to the third RUT to emulate the target at the RUT.

11. The apparatus of claim 10, wherein each of the first, second and third arrays of receive antennae are adapted to receive a signal from another of receive antenna of the first, second and third arrays of antennae, and to transmit the signal to a remaining one of the first, second and third arrays of antennae.

12. The apparatus of claim 1, wherein first and second radar device under tests are adapted to rotate to emulate the target at a plurality of angles to emulate the target at a plurality of locations across a field of view of the first and second radar device under tests.

13. The apparatus of claim 9, wherein the third RUT is adapted to rotate to emulate the target at a plurality of angles to emulate the target at a plurality of locations across a field of view of the third RUT.

14. The apparatus of claim 1, wherein the apparatus is adapted to emulate the target in a lateral and a vertical position by selectively switching from a transmit antenna of the first array to another of the transmit antennae of the first array of antennae.

15. The apparatus of claim 1, wherein the apparatus is adapted to emulate the target in a lateral and a vertical position by selectively switching from one of the transmit antennae of the second array to another of the transmit antennae of the second array.

16. The apparatus of claim 15, wherein a controller is adapted to perform the switching.

17. A system for testing for testing distributed aperture radar (DAR), the system comprising:
a controller comprising a processor and a memory that stores executable instructions;
a first chamber comprising a first array of transmit and receive antennae disposed on one side of the first chamber and a first RUT disposed on an opposing side of the first chamber, wherein at least one of the first array of transmit and receive antennae is connected to a first signal processor and the first array of transmit and receive antenna is adapted to emulate a target; and
a second chamber comprising a second array transmit and receive antennae disposed on one side of the second chamber and a second RUT disposed on an opposing side of the second chamber, wherein at least one of the second array of transmit and receive antennae is connected to a second signal processor and the second array of transmit and receive antennae are adapted to emulate the target.

18. The system of claim 17, wherein the first signal processor is connected to a memory that stores instructions, which when executed by the first signal processor, cause a test signal received at a receive antenna to manipulate the test signal to be transmitted by a transmit antenna to emulate a target.

19. The system of claim 18, wherein the receive antenna is in the first array and the transmit antenna is in the second array.

20. The system of claim 18, wherein the first signal processor and the memory are shared by a transmit antenna from the first array and a receive antenna of the second array, and the first signal processor is adapted to manipulate a test signal received at the receive antenna of the first array, and provide the manipulated test signal to the transmit antenna of the second array for transmission back to the firstRUT.
